(19) United States
(12) Patent Application Publication
(10) Pub. No.: US 2010/0188405 A1
(43) Pub. Date: Jul. 29, 2010

(54) SYSTEMS AND METHODS FOR THE GRAPHICAL REPRESENTATION OF THE WORKOUT EFFECTIVENESS OF A PLAYLIST

(75) Inventors: Allen P. Haughay, JR., San Jose, CA (US); Benjamin Rottler, San Francisco, CA (US)

Correspondence Address: KRAMER LEVIN NAFTALIS & FRANKEL LLP, 1177 Avenue of the Americas, New York, NY, 10036, US

(73) Assignee: APPLE INC., Cupertino, CA (US)

(21) Appl. No.: 12/361,243

(22) Filed: Jan. 28, 2009

(51) Int. Cl. G06T 11/20; G06F 17/30

(52) U.S. Cl. 345/440; 707/E17.001; 707/618

(57) ABSTRACT

Systems and methods are provided for a graphical representation of the workout effectiveness of a playlist. A particular playlist or collection of media items can be received. A burn graph can then be generated from the playlist, where the burn graph represents the expected effort level of a user who is exercising while listening to the playlist. The expected effort level can be determined by analyzing, for example, the beats per minute, tempo, mood, brightness, or genre of the media in the playlist. Additional user information such as, for example, a user's weight, age, height, stride length, resting heart rate, data from prior workouts, user's mood, or any combination of the above, can be taken into account when generating the burn graph.

### FIELD OF THE INVENTION

This relates to systems and methods for the graphical representation of the workout effectiveness of a playlist. In particular, this relates to systems and methods for generating a burn graph that can associate an exercise effort level with a playlist.

### BACKGROUND OF THE INVENTION

People work out for a variety of reasons such as enjoyment, personal satisfaction, to meet health goals, or to socialize with other people. As a few examples, exercise routines can include activities such as running, swimming, lifting weights, biking, using workout equipment such as elliptical machines, and rowing.

In addition, music can be added to an exercise routine as a form of enjoyment or motivation. For example, listening to music while working out can relieve boredom and encourage a person to continue exercising. As another example, faster, more enjoyable, or louder songs can motivate a person to increase their pace or to exercise harder. Accordingly, a person's effort level while working out or how hard they exercise can be related to the music he is listening to while exercising.

### SUMMARY OF THE INVENTION

Systems and methods for generating a graphical representation of the workout effectiveness of media are provided. The media can include, for example, a song, video, audio clip, or any other suitable type of media.

In some embodiments, a burn graph representing the workout effectiveness of a playlist of media items can be generated. The burn graph can generally represent a user's expected effort level during a workout if he were to listen to the playlist while exercising. The magnitude of the burn graph can be related to factors such as, for example, calories burned, pace, speed, strides per a unit of time, heart rate, or a combination of the above.

In some embodiments, to determine the expected effort level associated with a song or other type of media, various workout attributes of the media item can be determined. The determined workout attributes can include, for example, the beats per minute of the media item, the tempo of the media item, the genre of the media item, the mood of the media item, the brightness of the media item, or any combination of the above. By analyzing the entire playlist of media items and determining the expected effort levels for the media items, a burn graph representing the workout effectiveness of the playlist can be generated.

In some embodiments, the user can enter user-specific information that can be utilized to adjust the magnitude and effort level values of the burn graph. For example, the user can enter information such as user's weight, age, height, stride length, resting heart rate, physical fitness, current mood, any other suitable user information, or any combination of the above. In some embodiments, the user can enter workout-specific information such as, for example, weather conditions, type of exercise routine (e.g., running, biking, swimming, or lifting weights), or terrain conditions (e.g., hills, beaches, or sidewalks). Similarly, the magnitude and effort levels of the burn graph can be adjusted based on the workout-specific information.

In some embodiments, coaching cues can be added to a playlist based on the burn graph. For example, before a song that correlates to a jump in the expected effort level of the associated burn graph, an audio track of a person saying, “Get ready to pick up the pace!” can be inserted. As another example, visual or tactile coaching cues can be inserted into the playlist. For example, a picture, graph, or text can be displayed or the user device can vibrate to prompt a user to adjust their pace.

In some embodiments, an audio metronome can be added into the background of a playlist. The audio metronome can, for example, play a steady beat that corresponds to the expected effort level of the burn graph. For example, if the burn graph indicates a user should increase their effort level for a particular song, the beat of the audio metronome can be increased for that song. Similarly, if the burn graph indicates a user should decrease their effort level for a particular song, the beat of the audio metronome can be decreased for that song.

### BRIEF DESCRIPTION OF THE FIGURES

The above and other objects and advantages of the invention will be apparent upon consideration of the following detailed description, taken in conjunction with the accompanying drawings, in which like reference characters refer to like parts throughout, and in which:

FIG. 1 shows an illustrative user device in accordance with some embodiments of the present invention;

FIG. 2 shows a schematic view of an illustrative user device in accordance with some embodiments of the present invention;

FIG. 3 shows an illustrative burn graph in accordance with some embodiments of the present invention;

FIG. 4-6 show illustrative user interfaces in accordance with some embodiments of the present invention; and

FIG. 7 shows an illustrative process for generating a burn graph from a playlist in accordance with some embodiments of the present invention.

### DETAILED DESCRIPTION OF THE INVENTION

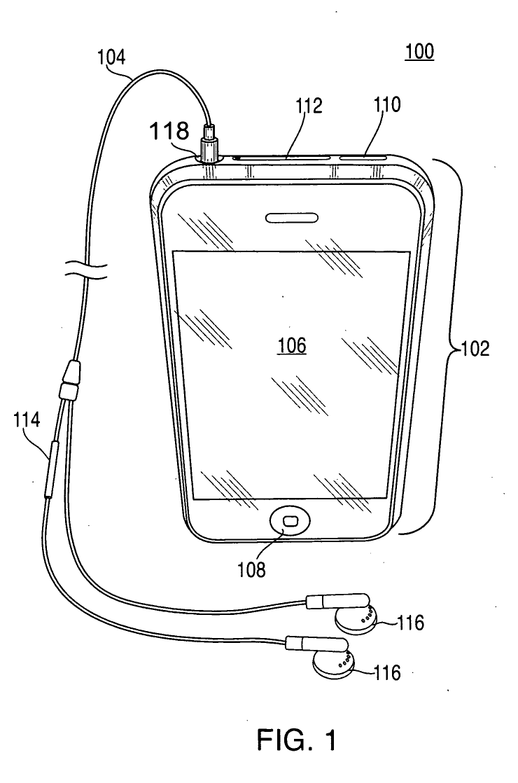

FIG. 1 shows illustrative user device 100 for creating or presenting a burn graph that is in accordance with some embodiments of the present invention. Although generally depicted as a portable, handheld device in FIG. 1, one skilled in the art could appreciate that user device 100 can include any suitable size or shape. For example, user device 100 can be a non-handheld device such as a desktop computer, a handheld device such as personal data assistant (“PDA”), a personal e-mail or messaging device (e.g., a Blackberry® or a Sidekick®), a cellular phone, a handheld media player such as an iPod™ (available from Apple Inc. of Cupertino, Calif.), a laptop computer, or any other suitable device.

User device 100 can include main device 102 and one or more of accessory device 104. Generally, any of the components of user device 100 described below can be integrated into main device 102, contained in accessory device 104, or both. Additionally, although accessory device 104 is depicted as being physically coupled to main device 102 in FIG. 1, accessory device 104 may alternatively be wirelessly coupled to main device 102.

There can be multiple ways of connecting accessory device 104 through, for example, connector 118. Persons skilled in the art will appreciate that connector 118 can be any suitable connector such as one or more USB ports, 30-pin connector ports, docks, expansion ports, and headset jacks.

User device 100 can include display screen 106. Further to the discussion above, display screen 106 does not need to be integrated into main device 102, and in other embodiments can be an accessory device that is physically or wirelessly coupled to main device 102. For example, display screen 106 can include a computer monitor, a television screen, a projection screen, a liquid crystal display (“LCD”), light emitting diode (“LED”) display, organic light-emitting diode (“OLED”) display, surface-conduction electron-emitter display (“SED”), carbon nanotubes, nanocrystal displays, or any other suitable screen. Display screen 106 can present various types of information to the user such as graphical and textual displays. This can include, for example, a burn graph, user-selectable options, playlists of media items, stored music, stored videos, stored photos, other stored data, and system information. In some embodiments, display screen 106 can function as a user input mechanism that allows for a touch screen or user input via a stylus.

User device 100 can also include one or more of user input mechanisms 108 and 110. These mechanisms can include, for example, one or more buttons, switches, track wheels, click wheels, or keyboards. User device 100 can include one or more of port 112 for coupling external data or hard drives into user device 100. For example, port 112 can enable user device 100 to receive SIM cards, flash drives, or external hard drives.

User device 100 can include any suitable user input/output devices such as microphone 114 and speakers 116. Although depicted as being contained in accessory device 104, one skilled in the art could appreciate that microphone 114 and speakers 116 may alternatively or additionally be contained in main device 102.

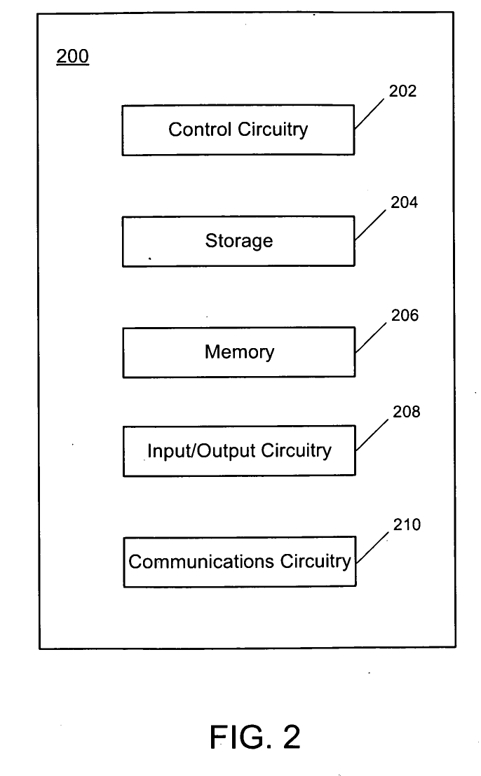

FIG. 2 shows a schematic view of an illustrative user device in accordance with some embodiments of the invention. For example, user device 200 can correspond to user device 100 of FIG. 1. User device 200 can include control circuitry 202, storage 204, memory 206, input/output circuitry 208, and communications circuitry 210. In some embodiments, one or more of user device components 200 can be combined or omitted (e.g., storage 204 and memory 206 can be combined). In some embodiments, user device 200 can include other components not combined or included in those shown in FIG. 2 (e.g., motion detection components, a power supply, or a bus), or several instances of the components shown in FIG. 2. For the sake of simplicity, only one of each of the components is shown in FIG. 2.

Control circuitry 202 can include any processing circuitry or processor operative to control the operations and performance of user device 200. For example, control circuitry 200 can be used to run operating system applications, firmware applications, media playback applications, or any other application. In some embodiments, the control circuitry can drive a display and process inputs received from a user interface.

Storage 204 can include, for example, one or more storage mediums including a hard-drive, solid state drive, flash memory, permanent memory such as ROM, any other suitable type of storage component, or any combination thereof. Storage 204 can store, for example, media data (e.g., music and video files), application data (e.g., for implementing functions on device 200), firmware, user preference information data (e.g., media playlists), authentication information (e.g. libraries of data associated with authorized users), wireless connection information data (e.g., information that can enable user device 200 to establish a wireless connection), and any other suitable data or any combination thereof.

Memory 206 can include one or more of cache memory, semi-permanent memory such as RAM, or different types of memory used for temporarily storing data. In some embodiments, memory 206 can also be used for storing data used to operate user device applications, or any other type of data that can be stored in storage 204. In some embodiments, memory 206 and storage 204 can be combined as a single storage medium.

Input/output circuitry 208 can be operative to convert (and encode/decode, if necessary) analog signals and other signals into digital data, and vice-versa. For example, input/output circuitry 208 can be operative to convert signals received from any suitable input mechanism, such as input mechanisms 108 and 110 of FIG. 1, into digital data. Although input/output circuitry 208 is illustrated in FIG. 2 as a single component of user device 200, several instances of input/output circuitry can be included in user device 200.

Communications circuitry 210 can include any suitable communications circuitry operative to connect to a communications network and transmit or receive communications (e.g., data) with user device 200. Communications circuitry 210 can be operative to interface with a communications network using any suitable communications protocol such as, for example, Wi-Fi (e.g., a 802.11 protocol), Bluetooth®, radio frequency systems (e.g., 900 MHz, 2.4 GHz, and 5.6 GHz communication systems), infrared, GSM, GSM plus EDGE, CDMA, quadband, other cellular protocols, VOIP, or any other suitable protocol.

In some embodiments, communications circuitry 210 can enable user device 200 to be coupled to a host device to perform functions such as, for example, data transfers, synching the user device, software updates, or any other suitable operation that can require user device 200 to be coupled to a host device. For example, in addition to storage 204, user device 200 can alternatively or additionally access media data (e.g., music and video files) from a remote database through communications circuitry 210.

In some embodiments, user device 200 can include a bus operative to provide a data transfer path for transferring data to, from, or between control processor 202, storage 204, memory 206, input/output circuitry 208, communications circuitry 210, and any other component included in user device 200.

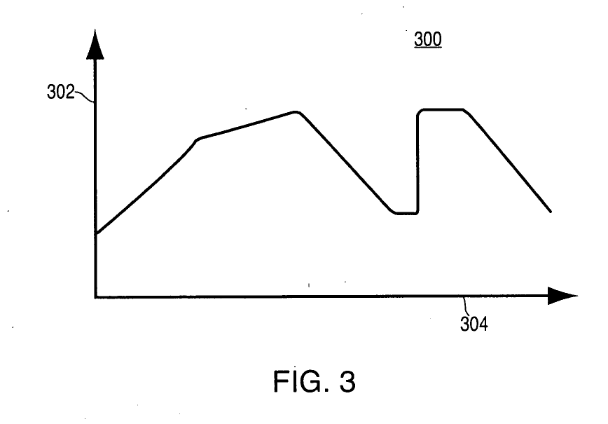

As mentioned above, this relates to a graphical representation of the workout effectiveness of a playlist. One way of representing the effectiveness of a workout is through a burn graph. Generally, a burn graph can provide a visual indication of a user's effort level throughout a particular workout. FIG. 3 shows an illustrative burn graph 300 in accordance with some embodiments of the present invention. Burn graph 300 can include y-axis 302 and x-axis 304. Y-axis 302 can generally represent the effort level of a workout. In some embodiments, y-axis 302 can be associated with factors such as calories burned, pace, speed, strides per a unit of time, heart rate, or a combination of the above. X-axis 304 can generally represent the length of a workout. For example, x-axis 304 can be associated with factors such as distance, total strides taken, or time. In some embodiments, burn graph 300 can be customized based on additional user information. For example, information such as a user's weight, age, height, stride length, resting heart rate, data from prior workouts, or any combination of the above can be utilized when calculating data such as, for example, calories burned or distance traveled. The calculated data can then be associated with values on burn graph 300.

When a person is exercising (e.g., jogging, swimming, running on a treadmill, pedaling a bike, using an elliptical machine, or performing any other suitable workout) music can be listened to as a form of entertainment and encouragement. For example, when jogging, a person may have a natural tendency to run in cadence with the beat of a song. Thus, when listening to a song with a faster tempo or a slower tempo, a person can be encouraged to, respectively, speed up or slow down their current pace. Accordingly, songs heard by a user during a workout can be correlated with the effort level of that workout. One way of visually representing a correlation between songs and effort level can be achieved through a burn graph.

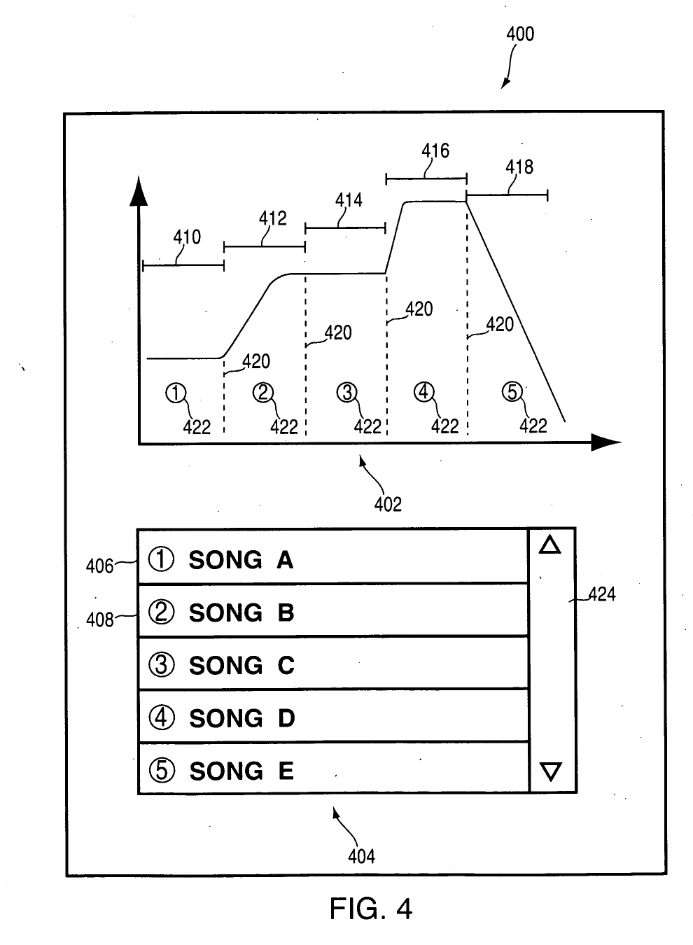

FIG. 4 shows an illustrative user interface 400 that can represent a correlation between burn graph 402 and media playlist 404. User interface 400 can, for example, be displayed on a display screen such as display screen 106 of FIG. 1. As described above, people can have a natural tendency to exert energy (e.g., run, walk, or pedal a bike) in cadence with a song. As one example, when exercising, a user may naturally adjust their strides per minute to be aligned with the beats per minute (“BPM”) of a song. Generally, the strides per a minute can be an even division (e.g., one, one-half, or one-quarter) of the BPM. For example, if a song averages 100 BPM, a user who is listening to the song may be encouraged to adjust their strides to 100 strides per minute, 50 strides per minute, or 25 strides per minute. Thus, the magnitude of a portion of a burn graph can be related to the BPM of a song that is associated with that portion of the burn graph. As another example, the mood of a song, the genre of the song, the brightness of a song, the tempo of a song, or any combination of the above can be used to determine the magnitude of an associated portion of a burn graph.

Playlist 404 can include a list of one or more media entries, such as media item 406 and media item 408. Although media item 406 and media item 408 are represented as songs in FIG. 4 (e.g., “Song A” and “Song B”), playlist 404 can include any suitable type of media item such as, for example, videos, audio files, songs, or any combination of the above. As used herein, when songs or playlists are described, one skilled in the art could appreciate that any suitable type of media could alternatively or additionally be included in place of the songs.

Based on the attributes of the media item (e.g., the BPM, tempo, genre, mood, or brightness of a song) in playlist 404, playlist 404 can be correlated to burn graph 402. For example, media item 406 (“Song A”) can be a slower song that correlates to the relatively low effort level of section 410 of burn graph 402. If the next song in playlist 404 (“Song B”) has a faster BPM than Song A, section 412 of burn graph 404 can accordingly depict a higher effort level than section 412. Song C may have roughly the same BPM as Song B, and can be associated with section 414 of burn graph 404 that is roughly the same effort level as section 412. Similarly, Song D can be associated with section 416 of burn graph 402, and Song E can be associated with section 418 of burn graph 402.

Generally, the first media item in playlist 404 can correspond to the first section of burn graph 402, the second media item of playlist 404 can correspond to the second section of burn graph 402, etc. In some embodiments, burn graph 402 can include a visual indication of which sections of burn graph 402 correspond to which media item of playlist 404. For example, burn graph 402 can include dividers 420 to mark the transition from one media item of the playlist to another media item of the playlist. In some embodiments, rather than a line such as divider 420, different colors can be used to mark the media item transitions. For example, in burn graph 402, section 410, section 412, and section 414 can be respectively colored green, blue, and red (or any other suitable colors or background designs) to indicate the transition from one media item to another. In some embodiments, labels 422 can label the sections of burn graph 402 with their corresponding media item. Labels 422 can be any suitable label to identify a particular media item of playlist 404 such as, for example, the number of the media item in playlist 404, the title of the media item, descriptive information about the media item (e.g., artist, album, composer, genre, or length of time of the media item), or any other suitable label.

Playlist 404 can include scroll bar 424 to allow for scrolling through portions of playlist 404. One skilled in the art could appreciate that various ways of depicting burn graph 402 and playlist 404 can be provided without departing from the present invention. For example, in some embodiments, the scroll bar 424 may not be present and the entirety of playlist 404 can be displayed. In some embodiments, burn graph 402 can have a scroll bar (e.g., along the x-axis, the y-axis, or both). In some embodiments, playlist 404 and the x-axis of burn graph 404 can both have a scroll bar. In this embodiment, as playlist 404 is scrolled through, burn graph 402 can likewise scroll through the burn graph such that the displayed portion of burn graph 402 continuously corresponds to the songs displayed in playlist 404.

Displaying a graphical representation of a burn graph associated with a media playlist (e.g., such as user interface 400 of FIG. 4) can increase the enjoyment and benefits received by a user who may workout to that playlist. For example, the burn graph can provide interesting, supplementary information about a workout by visually representing to a user the effort levels of different intervals of a workout and its relation to music being played. In this manner, by viewing a burn graph, a user can easily perceive areas of the workout where he can be prompted to exert more energy (e.g., with a faster song) and prompted to exert less energy (e.g., with a slower song). As another example, a burn graph that is associated with a playlist can allow a user to visually choose an exercise routine that, rather than prompting the user to run at an exact pace (e.g., prompting the user to run at 7.5 mph for 10 minutes), can prompt the user to more generally slow down or speed up their pace. Because the cues for the pace of the workout can be received audibly through songs (or any other suitable media item), a user can perform a particular exercise routine without requiring visual cues, such as a display showing his current speed or a message telling him to increase his speed.

In some embodiments, a user may already possess a particular playlist or collection of songs. The playlist can include, for example, a user-selected collection of songs or other media items the user enjoys, a computer-generated random “shuffle” of media items, a pre-packaged playlist of media items that can be purchased, or any combination of the above. The user may desire to exercise while listening to this playlist, and may like to see how well this playlist would function as a workout routine (e.g., the user would like to see what expected workout would result if he were to exercise while listening to this playlist). Accordingly, in some embodiments, a burn graph can be generated from a selected playlist to depict the playlist's workout effectiveness.

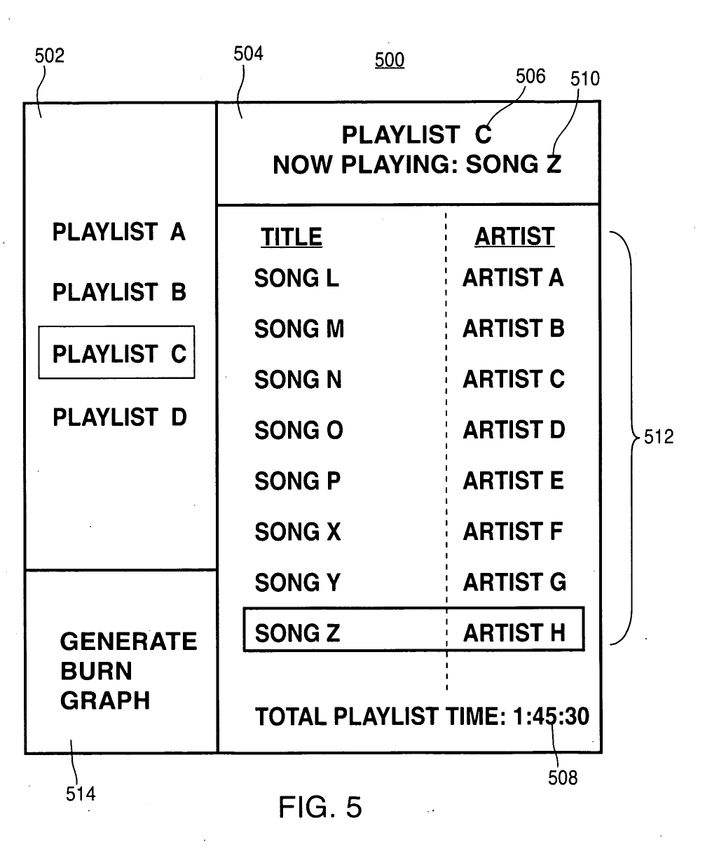

FIG. 5 shows an illustrative user interface 500 that can generate a burn graph from a playlist of songs (or any other suitable media items). In some embodiments, user interface 500 can include one or more user-selectable playlists of songs in window 502. Information related to a selected playlist can be displayed in window 504. For example, as illustrated in FIG. 5, “Playlist C” can be selected in window 502, and information related to Playlist C can be displayed in window 504. Information related to a selected playlist can include, for example, a playlist title 506, playlist duration 508, title 510 identifying a currently playing media item in the playlist, a listing 512 of information such as titles, artists, albums, composers, and genre of media items in the selected playlist, or any other suitable information related to a selected playlist. A burn graph may then be generated from a selected playlist by, for example, choosing a user-selectable option such as the “Generate Burn Graph” option in window 514.

In some embodiments, the burn graph can be generated in a pop-up window. For example, a window may pop-up over user interface 500 that displays a burn graph related to the selected playlist. In some embodiments, the generated burn graph can replace the current window (e.g., can replace user interface 500). In yet another embodiment, the burn graph can be generated in a window within user interface 500. For example, the burn graph can be generated within window 514 after the “Generate Burn Graph” option has been selected.

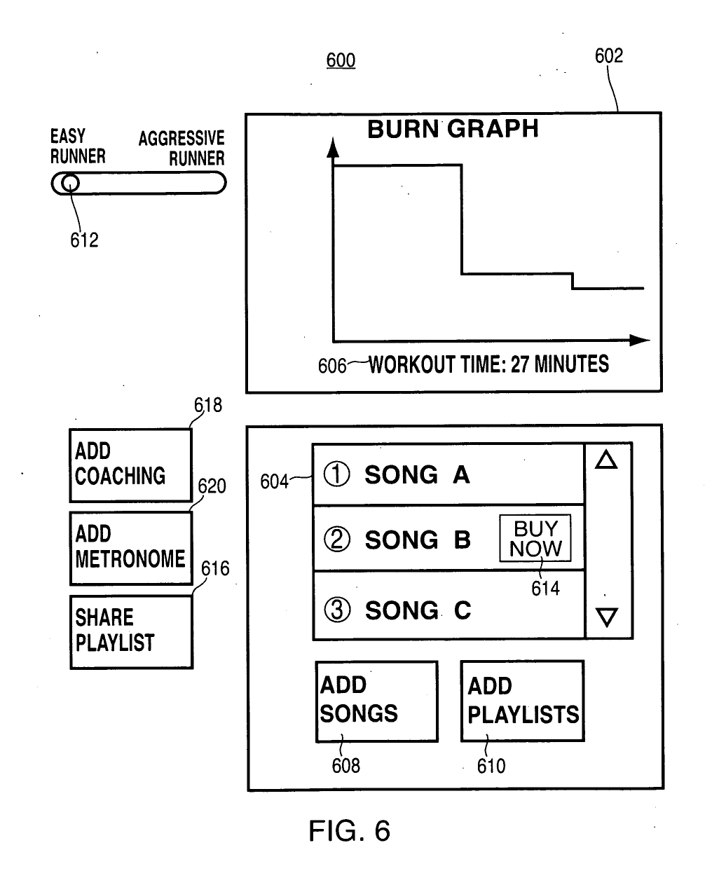

In some embodiments, a burn graph that is associated with a playlist of media items can be customized or updated. FIG. 6 shows illustrative user interface 600 including burn graph 602 that can be generated from playlist 604. In some embodiments, burn graph 602 can include workout time 606 that corresponds to the duration of playlist 604. A user may, for example, determine from burn graph 602 that if they workout to playlist 604, they will exercise harder at the beginning of the workout than at the end of the workout. However, the user may instead desire to exercise hardest at the end of the workout. Thus, in some embodiments, a user can change the order of playlist 604 to generate a burn graph 602 that represents a more desirable workout. As one example, as a user changes the order of the songs in playlist 604, burn graph 602 can update in real-time to portray the expected effort level of a user exercising to the updated playlist.

As another example, in some embodiments user interface 600 can include one or more of Add Songs option 608 and Add Playlists option 610. Add Songs option 608 and Add Playlists option 610 can, respectively, allow a user to add individual songs or entire playlists to playlist 604. Once again, in some embodiments burn graph 602 can update in real-time as songs, playlists, or both are added to playlist 604.

In some embodiments, a user can input user-specific information through, for example, slide bar 612. As one example, by adjusting slide bar 612, a user can indicate whether they are an “aggressive runner,” an “easy runner,” or somewhere in-between. Burn graph 602 can then be updated based on the value of slide bar 612. For example, if a user increases the value of slide bar 612 to indicate that they are a more aggressive runner, the magnitude or rates of changes of burn graph 602 can be increased in response. As mentioned above, a person can have a tendency to run in cadence with an even division of the BPM of a song. Thus, as another example, the “BPM divisor” can be determined based on the value of slide bar 612. For example, an “aggressive runner” value may generate a burn graph with a BPM divisor equal to one, while an “easy runner” value may generate a burn graph with a BPM divisor equal to one quarter. The magnitude of burn graph 602 can accordingly be adjusted based on the determined BPM divisor.

In some embodiments, slide bar 612 can alternatively indicate values such as a user's weight, height, stride length, age, resting heart rate, physical fitness, user's current mood, or any other suitable user information. As another example, slide bar 612 can indicate workout-specific information such as, for example, weather conditions, type of exercise routine (e.g., running, biking, swimming, or lifting weights), or terrain conditions (e.g., hills, beaches, or sidewalks). In other embodiments, there could be one or more of slide bar 612, or slide bar 612 could include a text box, radio button, check box, or any other suitable form of user input.

In some embodiments, the media items displayed in playlist 604 can be stored locally, for example in storage 204 of FIG. 2. In other embodiments, the playlist can be created from information related to the media items without the media item itself being available or stored locally. For example, the user device may access a remote database (e.g., access through communication circuitry 210 of FIG. 2) containing information related to various songs and media items. The information can include, for example, song titles, song durations, song artists, song composers, song albums, song genres, song moods, song brightness, song BMP, song tempo, or any combination of the above. A user can than create sample playlists from the song information and generate associated burn graphs. In some embodiments, the user may then have the opportunity to buy songs they have added to the playlist (e.g., by selecting Buy Now option 614). This can favorably allow a user to generate burn graphs and view sample workouts for songs they do not yet own, and then purchase songs that generate burn graphs indicating a desirable workout routine.

In some embodiments, a playlist, generated burn graph, or both can be shared with other users or user devices. For example, user interface 600 illustrates Share option 616 that can allow a user to share playlists and burn graphs. In some embodiments, the playlist or burn graph can be shared on a local network or made available to other devices that are coupled to the user device. In other embodiments, Share option 616 can allow the playlist to be posted to the Internet or added as an attachment to an email. In some embodiments, in order to prevent illegal sharing of media items that are not available to the general public (e.g., media items that must be paid for before they can be used) metadata or other tags can be embedded into the shared media items.

In some embodiments, coaching cues can be added to playlist 604 based on the attributes of burn graph 602 (e.g., through Add Coaching option 618). In some embodiments, the coaching cues can be a form of audible coaching. For example, a burn graph may show a large, sudden increase in the effort level during the transition from a first song to a second song in an associated playlist. An audio track of someone shouting, “Get ready to speed up!” can then be inserted into the playlist in between the first song and the second song. As another example, an audio track of a person saying “Keep up the pace” can be inserted in the middle of a long duration of the same effort level, or an audio track of a person saying, “Good job! Take a break” can be inserted directly before a drop in the effort level. As one example, a user can manually choose and insert coaching cues into the playlist. As another example, the coaching cues can be automatically chosen and inserted by the user device when a burn graph is generated. As yet another example, a combination of a manual and automatic system can be used to choose and insert the coaching cues.

In some embodiments, the coaching can be a visual or a tactile form of coaching. As one example, a display on the user device (e.g., a display such as display screen 106 of FIG. 1) could include text, pictures, graphs, or any other suitable visual display to coach the user. As another example, the user device can vibrate to give coaching cues to the user (e.g., the user device can vibrate to cue a user to speed up, slow down, or stop, or the user device can vibrate faster to indicate a faster pace and vibrate slower to indicate a slower pace).

In some embodiments, an audio metronome can be added, for example, by selecting Add Metronome option 620. The audio metronome can include a steady beat that is played in the background of a playlist. The speed of the audio metronome's beat can be determined based on the burn graph associated with the playlist. For example, the audio metronome can cue a user to a run at a pace that matches the effort level of the burn graph. As the playlist progresses and the effort level of the associated burn graph changes, the speed of the audio metronome can likewise change in relation to the burn graph.

As mentioned above, a burn graph can be generated and displayed on a non-handheld device such as a desktop computer, or on a handheld device such as a handheld media player. Thus, in some embodiments, a playlist and associated burn graph can be generated on a computer. The playlist can then, for example, be uploaded to a portable media player for a user to listen to during an exercise routine. In other embodiments, the burn graph can be generated directly on a handheld device that is used during the workout. For example, a burn graph can be generated from an On-The-Go playlist that is created on an iPod™ (available from Apple Inc. of Cupertino, Calif.).

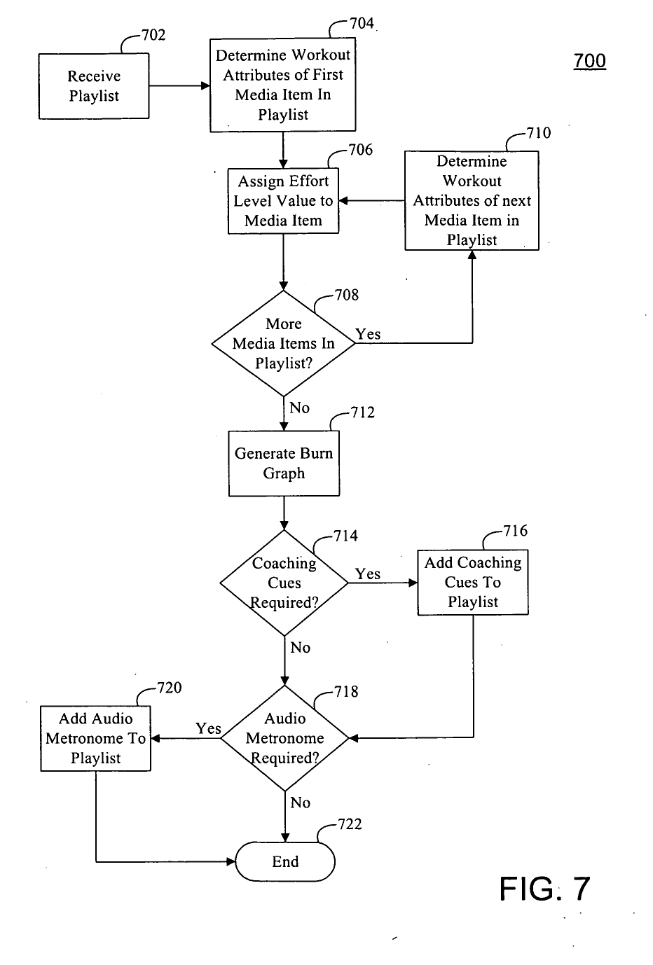

FIG. 7 shows illustrative process 700 for generating a burn graph from a playlist. At step 702, a playlist can be received. The playlist can include, for example, a user-selected collection of songs or other media items the user enjoys, a computer-generated random “shuffle” of media items, a pre-packaged playlist of media items that can be purchased, or any combination of the above. The media items can be songs, audio files, videos, or any combination of suitable media types.

At step 704, the workout attributes of the first media item in the playlist can be determined. For example, the media item's BPM, tempo, genre, mood, brightness, or any combination of the above can be analyzed. Based on the workout attributes, an effort level can be assigned to the first media item at step 706. In some embodiments, any available user-specific information can be taken into account when determining the effort level value. For example, a user's weight, height, age, resting heart rate, physical fitness level, prior workout information, mood, or any other suitable user information can be utilized when determining the effort level value. In some embodiments, any available workout-specific information can be taken into account when determining the effort level value. For example, weather conditions, type of exercise routine (e.g., running, biking, swimming, or lifting weights), or terrain conditions (e.g., hills, beaches, or sidewalks) can be utilized when determining the effort level value.

At step 708, process 700 can determine whether there are any additional media items in the playlist. If there are additional media items, the workout attributes of the next media item in the playlist can be determined at step 710 and an effort level value assigned to the media item at step 706. Generally, steps 708, 710, and 706 can continue to repeat until the workout attributes of all media items in the playlist have been determined and the media items have been assigned an effort level.

At step 712, a burn graph can be generated that is associated with the playlist received at step 702. The magnitude of the burn graph can be related to the effort levels values assigned to the media items at step 706. For example, a burn graph such as burn graph 602 of FIG. 6 can be generated.

In some embodiments, the absolute values of the effort levels can be used to generate the burn graph at step 712. For example, if the effort level is associated with an expected user speed, the absolute values of the expected user speed can be graphed (e.g., if the user is expected to run 3.5 mph, then 4 mph, and then 7 mph, these absolute values can be graphed on the burn graph).

In some embodiments, rather than graphing the absolute value of the effort level, a percentage or ratio change of the effort level can be graphed. In this case, the first media item in the playlist can be treated as a baseline for the burn graph. The subsequent media items in the playlist can then be graphed based on the ratio of the effort level of the first media item to the effort level of the subsequent media items. For example, if the effort level is associated with an expected user speed, and the user is expected to run 3.5 mph, 4 mph, and then 7 mph, the burn graph can show a baseline, and then a 14% increase in the base effort level followed by a 100% increase in the base effort level.

At step 714, process 700 can determine whether coaching cues are required. For example, a user can indicate by selecting Add Coaching option 618 of FIG. 6 that coaching cues are required. If coaching cues are required, they can be added to the playlist at step 716. For example, based on the shape of the burn graph, audio coaching cues, visual coaching cues, tactile coaching cues, or any combination of the above can be inserted into the playlist that was received at step 702. In some embodiments, process 700 can automatically determine which coaching cues to insert and were to insert them. In other embodiments, process 700 can receive a user input indicating which coaching cues should be inserted and where to insert them.

After the coaching cues are added or if coaching cues are not required, at step 718 process 700 can determine whether an audio metronome is required. For example, a user can indicate by selecting Add Metronome option 620 of FIG. 6 that an audio metronome is required. An audio metronome (e.g., a steady beat) can be inserted into the background of the playlist that was received at step 702. The speed of the audio metronome's beat can be determined based on the effort level values determined at step 706. For example, if the effort level of a portion of the burn graph increases, the speed of the audio metronome's beat can likewise be increased for the associated portion of the playlist.

After the audio metronome is added or if an audio metronome is not required, process 700 can end at step 722.

The process discussed above is intended to be illustrative and not limiting. Persons skilled in the art will appreciate that steps of the process discussed herein can be omitted, modified, combined, rearranged, or combinations of these, and any additional steps can be performed without departing from the scope of the invention.

The above described embodiments of the present invention are presented for purposes of illustration and not of limitation, and the present invention is limited only by the claims which follow.

What is claimed is:

1. A method for representing the workout effectiveness of a playlist, the method comprising:
receiving a playlist comprising a plurality of media items;
determining workout attributes for each of the plurality of media items; and
generating a burn graph based on the determined workout attributes, wherein the burn graph depicts the effort level expected from a user listening to the playlist over the length of a workout.

2. The method of claim 1, wherein generating a burn graph further comprises:
receiving user-specific information; and
adjusting the magnitude of the burn graph based on the received user-specific information.

3. The method of claim 1, wherein generating a burn graph further comprises:
receiving workout-specific information; and
adjusting the magnitude of the burn graph based on the received workout-specific information.

4. The method of claim 1, further comprising:
identifying a particular position on the burn graph;
generating a coaching cue, wherein the coaching cue is generated based on the shape of the burn graph at the particular position;
identifying a location of the playlist that is associated with the particular position; and
inserting a bookmark for the coaching cue into the location of the playlist.

5. The method of claim 1, further comprising:
generating an audio metronome, wherein the beat of the generated audio metronome changes based on the magnitude of the burn graph; and
adding the generated audio metronome into the playlist.

6. The method of claim 1, wherein determining workout attributes comprises:
accessing a remote database; and
retrieving workout attributes for each of the plurality of media items from the remote database.

7. The method of claim 1, further comprising:
providing an opportunity for a user to purchase at least one of plurality of media items.

8. The method of claim 1, further comprising:
updating the burn graph in response to receiving a modification to the playlist, wherein the updated burn graph depicts the effort level expected from the user listening to the modified playlist over the length of the workout.

9. The method of claim 1, wherein the burn graph comprises a visual indication of which portions of the burn graph correspond to which media items in the playlist.

10. The method of claim 1, wherein the workout attributes comprise one or more of a media item's title, a media item's genre, a media item's beats per minute, a media item's tempo, a media item's brightness, and a media item's mood.

11. A system for displaying a user interface providing a graphical representation of the workout effectiveness of a playlist, the system comprising:
a host device, the host device comprising:
a display
a processor operative to:
receive a playlist comprising at least one media item;
generate a graph representing the workout effectiveness of the received playlist; and
direct the display to display the generated graph.

12. The system of claim 11, further comprising:
a portable device, the portable device comprising:
communications circuitry operative to receive the playlist from the host device; and
output circuitry operative to play back the at least one media item of the playlist.

13. The system of claim 12, wherein the host device and the portable device are the same device.

14. The system of claim 11, wherein the processor is further operative to:
determine workout attributes for the at least one media item; and
define the graph from the determined workout attributes.

15. The system of claim 11, wherein:
the host device comprises communications circuitry operative to:
access a remote database; and
retrieve workout attributes associated with the at least one media item from the remote database; and
the processor is further operative to define the graph from the accessed workout attributes.

16. An electronic device comprising:
a display;
storage operative to store a plurality of media files; and
a processor operative to:
generate a playlist comprising at least one of the plurality of media files;
determine workout attributes associated with each of the at least one of the plurality of media files; and
generate a graphical representation of the workout effectiveness of the playlist over time, wherein the values of the graphical representation change based on the workout attributes of the at least one of the plurality of media files played back at each moment of time.

17. The electronic device of claim 16, wherein the graphical representation is a burn graph.

18. The electronic device of claim 16, wherein the processor is further configured to:
identify user-specific information; and
adjust the magnitude of the graphical representation based on the identified user-specific information.

19. The electronic device of claim 16,
identify workout-specific information; and
adjust the magnitude of the graphical representation based on the identified workout-specific information.

20. Machine-readable media for representing the workout effectiveness of a playlist, comprising machine-readable instructions recorded thereon for:
receiving a playlist comprising a listing of a plurality of media items;
determining workout attributes for each of the plurality of media items; and
generating a burn graph based on the determined workout attributes, wherein the burn graph depicts the effort level expected from a user listening to the playlist over the length of a workout.

21. The machine-readable media of claim 20, further comprising machine-readable instructions recorded thereon for:
uploading the playlist to a portable media player; and
syncing the media items stored on the portable media player with the plurality of media items of the playlist.

22. The machine-readable media of claim 20, further comprising machine-readable instructions recorded thereon for:
accessing a remote database;
retrieving media item information for each of the plurality of media items from the remote database; and
determining workout attributes from the media item information.

23. The machine-readable media of claim 20, further comprising machine-readable instructions recorded thereon for:
generating a user-selectable option, wherein the user-selectable option allows for purchasing at least one of the plurality of media items.
